(19) United States
(12) Patent Application Publication
(10) Pub. No.: US 2019/0050213 A1
(43) Pub. Date: Feb. 14, 2019

(54) SYSTEM AND METHOD FOR GENERATING A DOMAIN-SPECIFIC PROGRAMMING LANGUAGE PROGRAM FROM A CLOUD-BASED COMPUTING SYSTEM

(71) Applicant: FUGUE, INC., Frederick, MD (US)

(72) Inventors: Robert SCHANAFELT, Frederick, MD (US); Nathaniel S. MCCOURTNEY, Frederick, MD (US)

(73) Assignee: FUGUE, INC., Frederick, MD (US)

(21) Appl. No.: 16/100,983

(22) Filed: Aug. 10, 2018

Related U.S. Application Data
(60) Provisional application No. 62/544,502, filed on Aug. 11, 2017.

(51) Int. Cl. G06F 8/41; G06F 8/30; G06F 21/62; H04L 12/24; G06F 17/30

(52) U.S. Cl. CPC G06F 8/447; G06F 8/31; G06F 17/30991; H04L 41/0893; G06F 21/62

(57) ABSTRACT

A system and method for generating domain-specific programming language for cloud services infrastructure from a pre-existing cloud-based computing system is provided. In one example, a transcriber tool can generate a plurality of queries directed at a cloud service provider application program interface. The results of those queries can then be to generate a symbolic representation of the domain-specific language. Once the symbolic representation has been rendered, the symbolic representation can then be converted into a domain-specific language program. In one or more examples, the generated code can be used to clone the pre-existing cloud-based computing system. In another example, the generated code can be used to take control of the pre-existing cloud-based computing system.

### CROSS-REFERENCE TO RELATED APPLICATION

This application claims the benefit of U.S. Provisional Application No. 62/544,502, filed Aug. 11, 2017, the entire contents of which are incorporated herein by reference.

### FIELD OF THE DISCLOSURE

The invention relates to a system and method for generating a domain-specific programming language program based on a pre-existing computing system that is implemented on a cloud service provider.

### BACKGROUND OF THE INVENTION

A number of cloud service providers sell various cloud services to execute compute instances on behalf of their customers. For example, AMAZON sells its AMAZON WEB SERVICES (AWS) service, GOOGLE sells its GOOGLE APP ENGINE service, and others sell similar services. In exchange for a fee, AMAZON, GOOGLE, and other cloud service providers provide the use of their servers and other infrastructure to customers for a limited time in the form of a cloud service instance. The fee may vary depending on a time/date that the cloud service instance is to be run, a performance of the cloud service instance (e.g., throughput, latency, etc.), whether the offered cloud service instance is a spot instance or a standard instance, and/or other attributes.

Integrating use of cloud services into an organization's processes can be difficult. Conventionally, users can manually enter input an input into a cloud services command line interface (CLI) or graphical user interface (GUI). Making the process of creating cloud infrastructure more user friendly can be achieved through the use of specialized programs in conventional programming languages that attempt to instantiate, monitor, and update cloud instances.

For computing system architects who have previously built and maintained computing systems on a cloud service provider without the use of a domain-specific programming language, changing over their methods of implementing computing infrastructure to using a domain-specific programming language can be problematic because it can mean that the portion of their computing infrastructure that predates the use of a domain-specific programming language will be built and maintained in an inconsistent manner with the portions of their computing infrastructure that will be built using a domain-specific programming language.

Thus, an ability to convert their pre-existing cloud computing infrastructure into a domain-specific programming language program, so that it can be implemented and maintained in a manner that utilizes the benefits of a domain-specific programming language-built cloud computing infrastructure can ensure a consistent approach to computing system development.

### SUMMARY OF THE DISCLOSURE

Accordingly, the following disclosure is related to a domain-specific language for cloud services infrastructure that allows for a user to create a computing environment using a user-friendly syntax that can be converted into code that is readable by a cloud computing services provider and further generating domain specific language programs based on pre-existing cloud computing systems.

In one example, a cloud computing system implemented on an account stored within a cloud service provider can be accessed. The application programing interface (API) of the cloud service provider can be queried to determine the computing infrastructure that exists on the cloud service provider. The results of the query can be converted into a symbolic language that can then be used to generate code in the domain-specific programming language.

In one or more examples, and in addition to the example above, the generated domain-specific programming language code can be used to create a “clone” of the computing system that was used to create the domain specific language code. Additionally, or in one or more separate examples, the generated domain-specific programming language code can be used to “take control” of the cloud-based computing system that was used to create the domain-specific cloud. Taking control of the cloud-based computing system can include monitoring the computing system to determine if any configuration drift has occurred over time and using the domain-specific language code to effect any changes to the cloud-based computing system.

### BRIEF DESCRIPTION OF THE DRAWINGS

FIG. 1 illustrates a system of providing and executing a domain-specific programming language for cloud services infrastructure, according to an implementation of the invention.

FIG. 2 illustrates a process flow diagram of various system components for providing and executing a domain-specific programming language for cloud services infrastructure, according to examples of the disclosure.

FIG. 3 illustrates an exemplary runtime environment of a compiled domain-specific programming language for cloud services infrastructure, according to examples of the disclosure.

FIG. 4 illustrates a process of compiling a domain-specific programming language for cloud services infrastructure, according to examples of the disclosure.

FIG. 5 illustrates an exemplary explain process according to examples of the disclosure.

FIG. 6 illustrates a process of executing a domain-specific programming language for cloud services infrastructure, according to an implementation of the invention.

FIG. 7 illustrates an exemplary method for generating a domain-specific programming language file from a pre-existing cloud-implemented computing system, according to examples of the disclosure.

FIG. 8 illustrates an exemplary method of cloning a cloud-based computing system by generating a domain-specific program file from a pre-existing cloud-implemented computing system, according to examples of the disclosure.

FIG. 9 illustrates an exemplary method of taking control of a cloud-based computing system by generating a domain-specific program file from a pre-existing cloud-implemented computing system, according to examples of the disclosure.

FIG. 10 illustrates an exemplary process for applying validations to domain-specific programming language files generated from a pre-existing cloud-based computing system, according to examples of the disclosure.

FIG. 11 illustrates an exemplary computing device, according to examples of the disclosure.

### DETAILED DESCRIPTION OF THE INVENTION

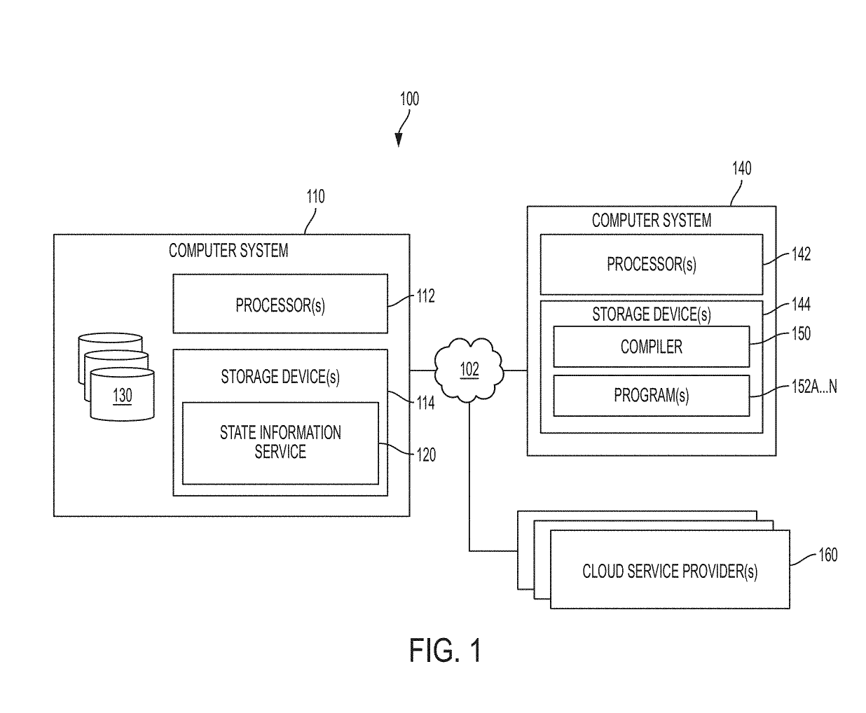

FIG. 1 illustrates a system 100 of providing and executing a domain-specific programming language for cloud services infrastructure (hereinafter, “domain-specific programming language” for convenience), according to an implementation of the invention. The system may be used to integrate references to external entities, such as cloud service compute instances, directly into a domain-specific programming language, allowing developers to easily integrate cloud services directly using the domain-specific programming language.

For illustration and not limitation, the external entities will be described as “cloud compute instances” (e.g., compute instances executed at a computer operated by a cloud service provider) that may be referenced directly within the domain-specific programming language described herein. However, other external entities (e.g., external to a given memory of a computer device that executes code that uses the domain-specific programming language described herein) may be used as well. As an example, the external entities can include DNS entries, binary objects, shared queues, database tables, etc.

The system may be used to facilitate checking against the type and state of an external entity in the language itself, including at authoring, build, and run times. Furthermore, the system may facilitate compilation, type checking, and debugging while authoring programs against external entities, as opposed to requiring testing to be performed to find errors and bugs.

Language primitives that are references to infrastructure or other external entities

Typically, in a programming language, a variable may be resolved to an address in memory at runtime. For example, if one were to define my-thing=123456, this would put the value 123456 to a location in memory. After definition, any code using my-thing would either get a reference to that memory address or would receive a copy of the value.

Using the domain-specific programming language described herein, references to external entities (not in memory) as variables may be used. For example, by defining my-thing=this-instance, this-instance would be resolved to a URL or other identifier of a running virtual computer, as opposed to an address in memory. This allows for checking against the type and state of an external entity in the language itself, including at authoring, build, and run times. The reference may be set by another program, manual configuration (e.g., at compile time), and/or other processes. By using language primitives that are references to cloud services infrastructure, the system facilitates checking, at compile and debug time, for the legitimacy of the reference, and to have a valid reference at runtime. Computing infrastructure can refer to components within a computing system that are being provided by a cloud service rather than having to use physical on-site devices. For instance, computing infrastructure can refer to computing devices such as virtual machines, load balancers, virtual networks, data storage services, domain name services, disk imagers, containers, clusters, and lambda instructions. These examples are not meant to be limiting, and are only provided as examples. The domain-specific programming language further facilitates compilation, type checking and debugging while authoring programs against external entities as opposed to requiring testing to be performed to find errors and bugs.

Lexical scoping that maps to abstractions of external entities.

In typical programming languages, lexical scoping is a way to organize pieces of code such that names can be re-used and also to allow for segmentation and encapsulation of elements of the program. For example, a private field in an object-oriented language prevents direct access to that data from outside the instance of the class in which it is defined.

Using the domain-specific programming language described herein, lexical scoping may be mapped onto collections of entities that aren't a native part of the language. For example, a compute instance may be defined using the reference to the external entity method described above: my-thing=this-instance, where this-instance is a pointer to an actual entity in the runtime environment.

Using external-entity lexical scoping, the system may make this-instance a child of this venue, where this-venue may include an arbitrary collection of entities. If this-instance was not public to the scope of the calling code, the compiler would return an error when directly referencing. This may occur when, for example, the scope of a variable was limited to a particular set of entities. The external entity may be associated with a single cloud service provider or different cloud service providers, the identification of which may be associated with a given variable or reference.

Externalizing the language runtime state information to a service.

In order to facilitate these and other benefits, the system may maintain state information of all references and shared variables across program boundaries. The system may make the state information accessible via a state information service that understands the language features of the domain-specific programming language.

At compile time, the compiled code can be processed by an interpreter module of the run time environment (explained in detail below) that may query the state information service to identify a variable in scope to use in the language in order to determine if it exists, and, if so, whether it is in scope to reference. The state information service may also deliver details on how the entity may be used, such as available functions or operations.

The state information service may keep detailed version information on the state of the variable. For example, if user A creates an entity via compiling and running a program, a corresponding variable may appear in the state information service, along with a serial number (or other version information) set to 1. In some examples, the corresponding variable can be a unique hash derived from the computing infrastructure's instance in the program. During the normal operations of the entity, its state changes (e.g., to another Internet Protocol address). A second program that initiates the change may update the table with the new IP address and may increment the serial number to 2. When a third program references the entity, and has a version 1 understanding of the state, it sees that the new serial number is 2 and may query the state information service for the latest version.

The state information may be made generic and scoped across all the entities the organization wishes to have available. In this way, multiple users across many parts of an organization may dynamically interoperate with the products of its peers in other teams.

Other uses of system 100 are described herein and still others will be apparent to those having skill in the art. Having described a high-level overview of some of the system functions, attention will now be turned to various system components that facilitate these and other functions.

The above infrastructure primitives and the lexical scoping applied to them, as discussed above, can be used to create functions that can yield patterns of infrastructure based on certain arguments inputted into those functions. The code example provided below, is an example of an enumeration type:

```
Type IcmpDescription:
      | Ping
      | DestinationUnreachable
      | RedirectMessage
```

The code example provided below is an example of a data structure type that can define the properties of an “icmp.” In the example below, the icmp type has the property values “type” and “code,” and these properties are expressed as integers.

```
Type Icmp:
      | type: INT
      | code: INT
```

The code example below illustrates an example function using the domain specific language. The example code below takes an infrastructure description and evaluates to an ICMP (machine data).

| Icmp fromDescription(IcmpDescription icmp): | |
|---|---|
| Case icmp of | |
| \| ping | {code: 0, type: 0} |
| \| DestinationUnreachable | {code: 0, type: 3} |
| \| Redirect Message | {code: 0, type: 5} |

The above functions can be evaluated at compile time by the explain function described in further detail below.

### Exemplary System Architecture

System 100 may include a computer system 110, a computer system 140, one or more cloud service providers 150, and/or other components.

### Computer System 110

Computer system 110 may include one or more processors 112 (also interchangeably referred to herein as processors 112, processor(s) 112, or processor 112 for convenience), one or more storage devices 114 (which may store a state information service 120, hereinafter SIS 120 for convenience), one or more entity state information databases 130, and/or other components. Processors 112 may be programmed by one or more computer program instructions. For example, processors 112 may be programmed by SIS 120 and/or other instructions.

### Computer System 140

Computer system(s) 140 may each include one or more processors 142 (also interchangeably referred to herein as processors 142, processor(s) 142, or processor 142 for convenience), one or more storage devices 144 (which may store a compiler 150A, one or more programs 152, and/or other instructions), and/or other components. Processors 142 may be programmed by one or more computer program instructions. For example, processors 142 may be programmed by compiler 150, programs 152, and/or other instructions.

### Cloud Service Providers 160

Cloud service providers 160 may include entities that sell various cloud services to execute compute instances on behalf of their customers. For example, AMAZON sells cloud service instances using its AMAZON WEB SERVICES (AWS) service, and GOOGLE sells cloud service instances using its GOOGLE APP ENGINE service. In other examples, cloud service providers can also include other specialized providers who provide non-compute services, such as content delivery networks, domain name service, etc.

Cloud service providers 160 may also include entities that provide markets, or exchanges, for cloud services. For example, cloud service providers 160 may include markets that sell cloud service instances on behalf of others that actually provide the cloud service instances using their infrastructure. In this manner, system 100 may leverage exchanges that may sell various cloud service instances from different entities.

Although illustrated in FIG. 1 as a single component, computer system 110 and computer system 140 may each include a plurality of individual components (e.g., computer devices) each programmed with at least some of the functions described herein. In this manner, some components of computer system 110 and/or customer computer system 140 may perform some functions while other components may perform other functions, as would be appreciated. The one or more processors 112, 142 may each include one or more physical processors that are programmed by computer program instructions. The various instructions described herein are exemplary only. Other configurations and numbers of instructions may be used, so long as the processor(s) 112, 142 are programmed to perform the functions described herein.

Furthermore, it should be appreciated that although the various instructions are illustrated in FIG. 1 as being co-located within a single processing unit, in implementations in which processor(s) 112, 142 includes multiple processing units, one or more instructions may be executed remotely from the other instructions. In addition, at least some of the functions described herein with respect to processor(s) 112 may be performed by processor(s) 142, and vice versa. For example, processor(s) 112 may be programmed by compiler 150, programs 152, and/or execute a runtime environment for programs 152. Likewise, processor(s) 142 may be programmed with state information service 120.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor 112 as well as data that may be manipulated by processor 112. The storage device may comprise floppy disks, hard disks, optical disks, tapes, or other storage media for storing computer-executable instructions and/or data.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configure hardware.

The entity state information database 130 (and/or any other database) described herein may be, include, or interface to, for example, an Oracle™ relational database sold commercially by Oracle Corporation. The example database provided above is not meant to be limiting, and the entity state information database 130 could include, or be interfaced to other databases, such as Informix™, DB2 (Database 2), Amazon DynamoDB™, or other data storage, including file-based or query formats, platforms, or resources such as OLAP (On Line Analytical Processing), SQL (Structured Query Language), a SAN (storage area network), Microsoft Access™, or others may also be used, incorporated, or accessed. The database may comprise one or more such databases that reside in one or more physical devices and in one or more physical locations. The database may store a plurality of types of data and/or files and associated data or file descriptions, administrative information, or any other data.

### Exemplary System Processing Operations

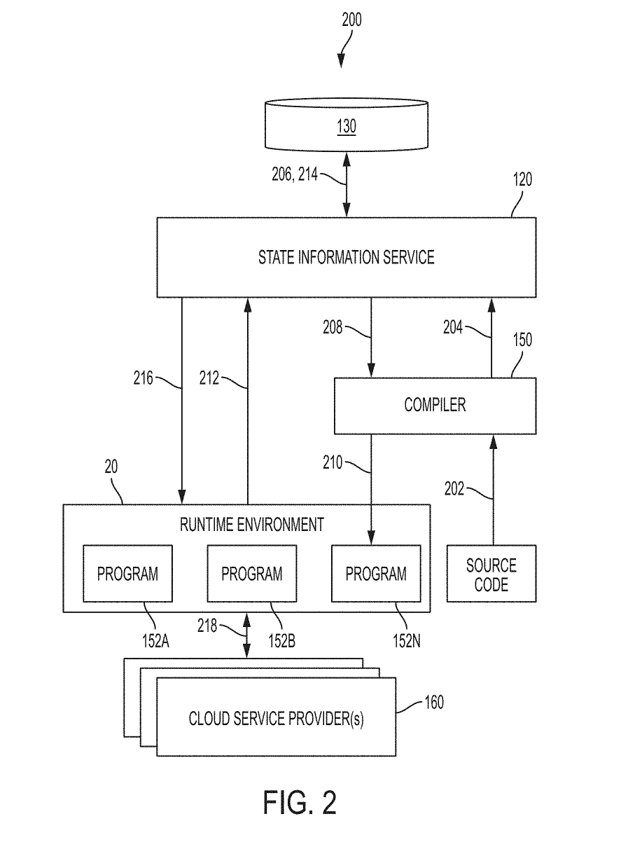

FIG. 2 depicts a process flow diagram 200 of various system components for providing and executing a domain-specific programming language for cloud services infrastructure, according to an implementation of the invention. The various processing operations and/or data flows depicted in FIG. 2 are described in greater detail herein. The described operations may be accomplished using some or all of the system components described in detail above and, in some implementations, various operations may be performed in different sequences, and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 202, source code in the domain-specific programming language for cloud services infrastructure may be received. For example, a developer may draft the source code to be received and compiled by compiler 150.

The compiled code generated by compiler 150 may be sent to the run time environment 20, in which an explain action can be initiated (described further below), and a query can be sent to SIS 120 to identify a variable in scope to the use in the source code to determine whether the variable exists, and, if so, whether the variable is in scope to the reference.

In an operation 206, SIS 120 may query entity state information database 130 to obtain the state information for the variable and/or the reference.

SIS 120 may obtain and provide any relevant state information (which may indicate an existence of the variable, its scope, a reference to an external entity such as a compute instance provided by cloud service provider 150, how an entity may be used such as its available functions, etc.) to the other components in the run time environment (or return NULL or other indication that the variable does not exist).

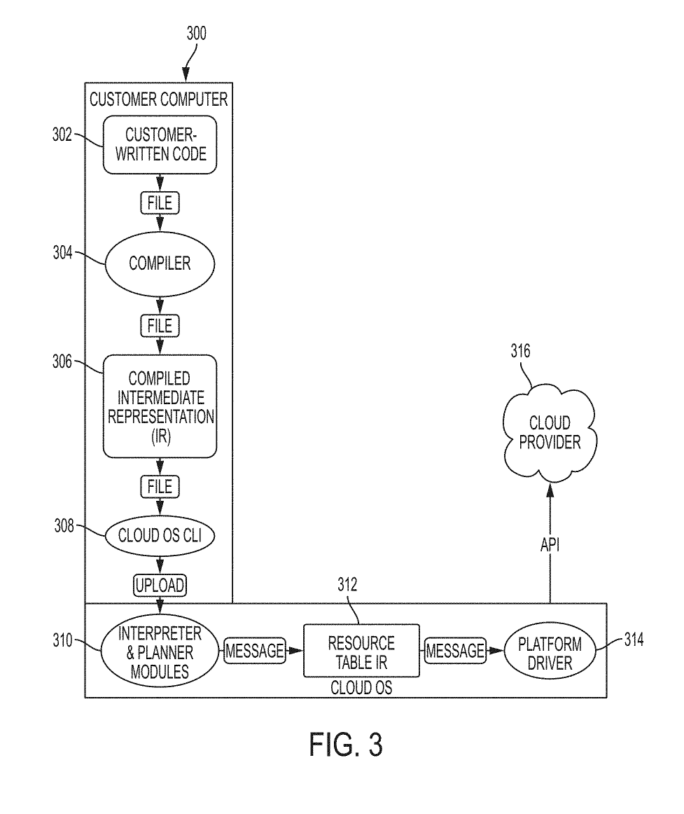

In an operation 210, compiler 150 may generate an executable program (hereinafter referred to as program 152A for convenience) if the variable exists and is in scope based on the state information. Program 152A may be placed run in runtime environment 20, along with other programs (152B, . . . N) that have been compiled by compiler 150. The runtime environment is discussed in detail below with respect to FIG. 3.

In an operation 212, runtime environment 20 may execute program 152B. For example, program 152B may be called to run in runtime environment 20 by a human user, a process, and/or other user. Runtime environment 20 may query SIS 120 to identify a variable in scope to the use in the program 152B to determine whether the variable exists, and, if so, whether the variable is in scope to the reference. For example, runtime environment 20 may transmit the query via network 102 to SIS 120.

In an operation 214, SIS 120 may query entity state information database 130, as described with respect to operation 206.

In an operation 216, SIS 120 may obtain and provide any relevant state information to runtime environment 20, as described before with respect to operation 208. Runtime environment may cause an error (e.g., a runtime fault) to occur if a given variable is not in scope to the calling compiled code (program 152B). Otherwise, runtime environment 20 may obtain a current state of a given variable in program 152B at the time of execution so that any state changes related to a referenced entity (e.g., compute instance executing at a cloud service provider 160) may be accounted for during execution of program 152B.

In an exemplary operation of programs in runtime environment 20, a user may compile and execute program 152A, which may include a variable that references an entity and causes the entity to be created. For example, the created entity may include, without limitation, a compute instance at cloud service provider 160. In other words, using the domain-specific language described herein, instantiation of a variable may refer to, and cause to be created, a corresponding compute instance. In an implementation, the source code for program 152A may specify/define the cloud instance to which the variable is referenced or the cloud instance may be defined by a configurable parameter setting. Upon compilation, SIS 120 may store the variable, its reference, its state, how the compute instance may be used, and/or other state information using entity state information database 130.

Program 152B may also include the variable. When program 152B is compiled, an explain action can be executed in the run time environment (explained in further detail below) that may query SIS 120 to determine whether the variable is in-scope to program 152B. Likewise, when program 152B is run, runtime environment 20 may query SIS 120 to determine whether the variable is in-scope as well as obtain current state information related to the variable.

In some instances, program 152B may cause the variable to be updated. For example, program 152B may cause a replacement compute instance to replace the existing compute instance at cloud service provider 160, causing an addressable identifier (e.g., an Internet Protocol address) to be changed to refer to the replacement computer instance. Responsive to such change, runtime environment 20 may provide SIS 120 with the update, which may update entity state information database 130 with the updated information for the variable. In another example, changes to instances of computing infrastructure (i.e., variables) initiated by an external actor (such as a user manually operating the cloud computing environment interface can be reverted back to its original form, it is found that the altered form does not conform to the original instance of the computing instance specified by the user through the domain-specific programming language.

Program 152N may also include the variable. Variables from program 152N may be validated at compile and runtime, as described above. Program 152N, when executed, may obtain the current state information related to the variable. For instance, instead of a reference to a compute instance created by program 152A (which may have cause the compute instance to be created), a variable included in program 152N may reference the current compute instance, as updated by program 152B. In this manner, different programs may update the same variable, which may cause references for those variables to be updated as well. Using the domain-specific language described herein, different developers may therefore refer to different entities (such as compute instances at cloud service providers 160) natively within the language of the code.

FIG. 3 illustrates an exemplary run time environment of a compiled domain-specific programming language for cloud services infrastructure, according to examples of the disclosure. As illustrated in FIG. 3, at the customer/client computer 300, a user can compose computer code using a domain-specific programming language that specifies computing infrastructure to implement on a cloud-based computing service.

Once a user has generated the code, the code is compiled at step 304, wherein it is converted from a user-friendly syntax generated by the user into an intermediate representation (illustrated at step 306) that can be understood by the command line interface of an infrastructure operating system. At step 308, the infrastructure operating system can execute the compiled code 306 by building and tracking what the code declares.

The code can then be sent to the interpreter and planner modules 310 that convert the command line interface language (i.e., intermediate representation 306) into a series of specific instructions that can be executed by the infrastructure operating system. In one example the interpreter manager can use one or more planning modules to build the instructions. The interpreter manager can achieve this by employing a series of planning modules that accept, in some examples, resource tables at its input and generate resource tables in which any omissions in the syntax provided by the user are filled in. In one example, the planning modules can receive a resource table that specifies the properties of the computing infrastructure to be built. The interpreter manager can review a resource table sent by the user (in the form of compiled domain specific code) and send it to the series of planning modules based on what infrastructure needs have been declared by the user.

The planning modules alter the user's resource table and return it to the interpreter manager. This process may be repeated with other planning modules until the final correct version of the resource table is complete at step 312. The interpreter manager then converts the resource table into a machine instruction file which can be referred to as a low-level declaration of the computer infrastructure to be built on the cloud. The low-level declaration is then sent to the builder/driver 314 wherein the resource table is converted into a language that can be interfaced with the application program interface of a cloud provider 316.

As part of its operation, the interpreter and planner modules 310 can input the user-declared instances of computing infrastructure, as well as the scope of those declared instances generated by the user in the domain-specific computing language. The interpreter can query an external state information service database (discussed above) to determine if the type of computing instance declared by the user exists and, if so, the state information service can provide any relevant state information to the interpreter.

Once the computing infrastructure has been built on the cloud computing environment, the implemented infrastructure can be “persisted,” which means that the implemented infrastructure can be compared against the user's originally declared instance of the computing infrastructure as expressed in the domain-specific programming language. If any differences are found, the implementation of the computing infrastructure can be modified by the interpreter 310 so that the implementation of the infrastructure on the cloud matches the user's desired infrastructure.

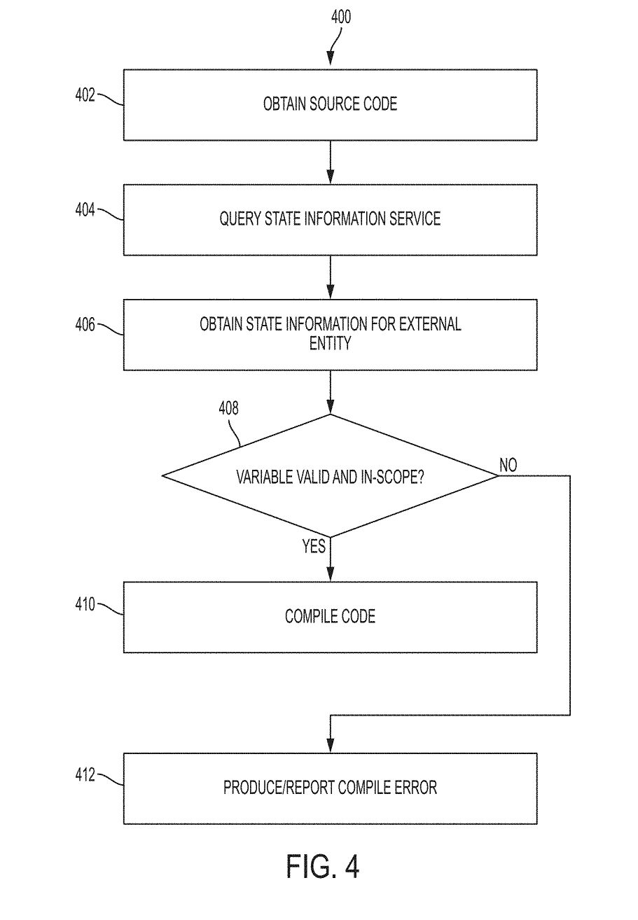

FIG. 4 illustrates a process 400 of compiling a domain-specific programming language for cloud services infrastructure, according to an implementation of the invention. The various processing operations and/or data flows depicted in FIG. 4 are described in greater detail herein. The described operations may be accomplished using some or all of the system components described in detail above and, in some implementations, various operations may be performed in different sequences, and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 402, source code in a domain-specific programming language may be obtained.

In an operation 404, a state information service may be queried to identify a variable in scope to the use in the language in order to determine if it exists and, if so, whether it is in scope to reference. Operation 404 may be repeated as necessary for variables that appear in the source code. As discussed above, the state information service may be queried during an explain action (explained in detail below) in which an interpreter located in the run time environment can query the state information service to determine if the variable exists and, if so, whether it is in scope to how it is referenced in the user generated code.

In an operation 406, state information may be obtained based on the query.

In an operation 408, a determination of whether a variable exists and/or is in scope may be determined.

In an operation 410, responsive to a determination that the variable exists and is in scope, the source code may be transmitted to the run time environment for implementation on the cloud service.

In an operation 412, responsive to a determination that the variable does not exist or is not in scope, a compile error may occur and be communicated.

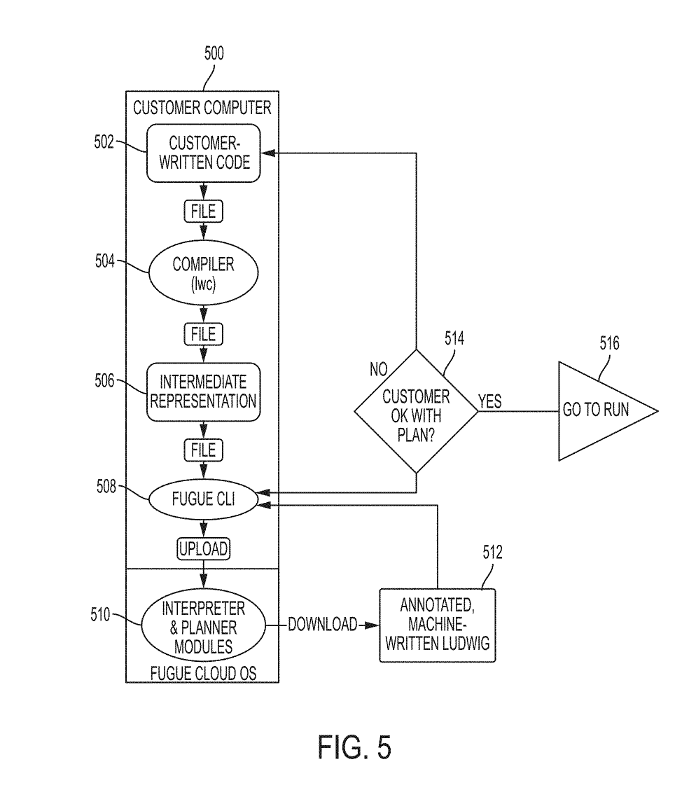

FIG. 5 illustrates an exemplary explain process according to examples of the disclosure. In the explain action illustrated in FIG. 5, steps 502, 504, 506, 508, and 510 operate in substantially the same way as their counterparts in FIG. 3 (i.e., steps 302, 304, 306, 308, and 310, respectively). However, in contrast to the process illustrated in FIG. 3, rather than converting the resource table generated by the interpreter into a machine instruction file, at step 512 the process returns the annotated resource table to the infrastructure operating system CLI 508.

As discussed above, as part of its operation, the interpreter can input the user-declared instances of computing infrastructure and query a state information-service database to determine if they exist. If it is determined that the instance of computing infrastructure does not exist, then the state information service can indicate to the interpreter that the declared instance does not exist and the use can be notified at step 512.

If however all the declared variables exist, the user can be presented with a plan for how the infrastructure is to be implemented at step 514. At step 514 the user can determine if the received implementation plan is acceptable and, if so, the process can move to step 516 wherein the annotated coded produced at step 512 is converted into machine code that is compatible with the command line interface of a cloud computing services provider.

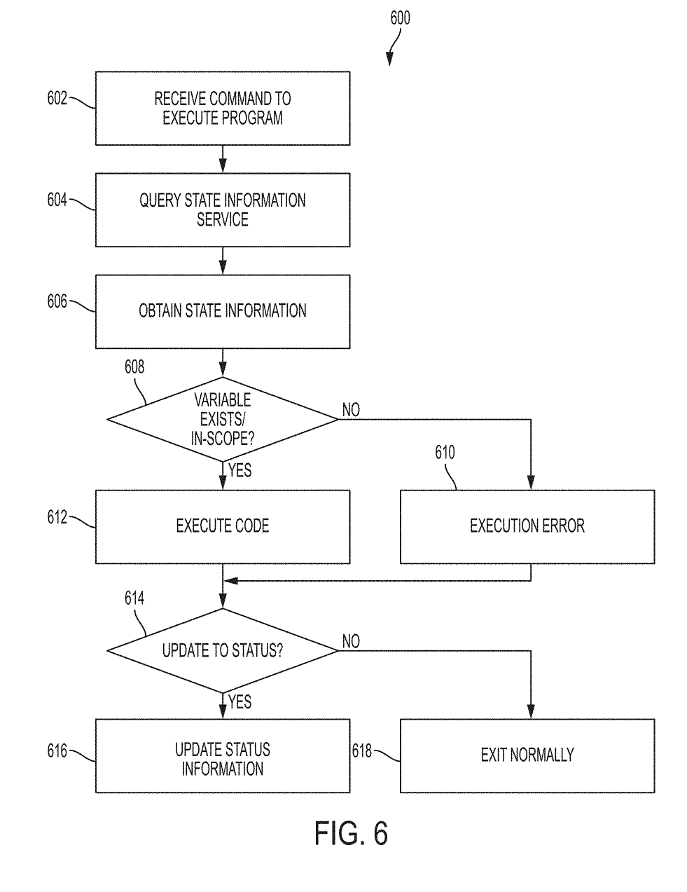

FIG. 6 illustrates a process 600 of executing a domain-specific programming language for cloud services infrastructure, according to an implementation of the invention. The various processing operations and/or data flows depicted in FIG. 6 are described in greater detail herein. The described operations may be accomplished using some or all of the system components described in detail above and, in some implementations, various operations may be performed in different sequences, and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 602, a command to execute a program compiled from source code using the domain-specific programming language may be received.

In an operation 604, a state information service may be queried to identify a variable in scope to the use in the language in order to determine if it exists and, if so, whether it is in scope to reference. Operation 604 may be repeated, as necessary, for variables that appear in the source code.

In an operation 606, state information may be obtained based on the query.

In an operation 608, a determination of whether a variable exists and/or is in scope may be determined.

In an operation 610, responsive to a determination that the variable does not exist or is not in scope, a runtime error may occur and be communicated.

In an operation 612, responsive to a determination that the variable exists and is in scope, the program may be executed. Operation 612 may be repeated until all variables have been processed. In some implementations, execution of the code may cause a compute instance at a cloud service provider to be instantiated. In these implementations, state information (e.g., IP address, version, how used, etc.) may be stored via a state information service. In this manner, other programs that use the same variable may access the state information for the instantiated compute instance.

In an operation 614, a determination of whether an update to state information of an entity associated with a variable occurred during execution of the program may be made. For example, a program that uses a variable corresponding to a compute instance may have changed an IP address associated with the compute instance. Operation 614 may be repeated until all variables have been processed.

Responsive to a determination that an update occurred, in an operation 416, the state information may be updated via a state information service.

In an operation 618, code execution may terminate normally (e.g., without error conditions).

The domain-specific language described above can use one or more libraries to aid in the development of software. A library can include a collection of resources used by computer programs (such as those written in a domain-specific language) to allow for the development of software using the domain-specific language. Libraries can include configuration data, documentation, help data, message templates, pre-written code, sub-routines, classes, values, type specifications.

Library code can be organized in such a way that it can be used by multiple programs that have no connection to one another. In other words, even if multiple users generate different programs using a coding language, by invoking a common library, each individual user-generated domain-specific programming language code file can use sub-routines and sub-programs that are contained within the library.

Therefore, in one example, a cloud computing infrastructure type can be invoked by a user-generated program, but the definition of that type can be stored in a library so that any program which instantiates the type can use the code contained with the library to define the type.

The utility of libraries in a programming language can be utilized to enforce system policies on user-generated code developed in the domain-specific language. In one example, if a business or other enterprise wishes to ensure that computing infrastructure built on a cloud by the use of a domain-specific language complies with one or more policies of the enterprise with respect to computing infrastructure, they may utilize a validations library that when invoked can check the user-generated code to ensure that it complies with the desired policies. If the code does comply with the policies, then the code is allowed to compile, and the computing infrastructure is built using the user-generated code. On the other hand, if the user-generated code does not comply with the enterprise's policies, the compiling of the code can be prevented and the user can be notified of the reason why the code was not allowed to be compiled.

In this way, the enterprise is able to allow for multiple individuals to build and maintain the enterprise's computing infrastructure via the cloud service provider, while at the same time ensuring that each and every instance of computing infrastructure built on behalf of the enterprise complies with the enterprise's self-defined policies.

A domain-specific language (and, by extension, a cloud operating system) can have the ability to add assertions to code that cause a compiler failure when the code it's related to does not meet its standards. That feature of the language can be known as Validations.

An administrator of the domain-specific language can write Validations and attach them to the Types affected with the keyword “validate,” in one example. Once the Types within the domain-specific language are attached, every time code written in the domain-specific language is compiled, it can check the user-generated code against the validations. This can happen locally on a domain-specific programming language author's desktop or on the cloud operating system where validations are enforced against running infrastructure.

To illustrate the method of validation described above an example is provided below. In the example, an enterprise wishes to enforce a policy wherein they desire to construct T types that only have the string “test” within them. Thus, when a user generates T types in the following manner:

type T:
| T {value: String}

The code will only be compiled if the string value contains the string “test” within it. In order to enforce this policy, a Validation library can be employed wherein the validations are laid out within the library. For example, the code below can be an example module to write to the Validations Library that can be used to enforce the policy described above.

```
import Ludwig.Validation as
check-t: fun(t):
  if String.equal(t.T.value, “test”) then
    success
  else
    failure(“check-t failed”)
```

Wherein “Ludwig” can be a generic name for the domain-specific language, and wherein the function check-t can be the function within the Validations library that checks instantiations of the type T to determine if the policy of having them constructed only with the string “test” in them is followed.

The Validations library can then “register” the validations using the validate keyword: validate check-t. Once the validation has been registered, every time a T is constructed, the check-t validation function will be used to ensure that the instantiation of T contains the string “test” within it.

Another example is provided below. In the example below, the system administrator wishes to enforce a specific policy regarding the use of a type called “Apple.” First, the system administrator can create a Validation for the type “Apple” using the following code:

```
import Fugue.System.Apple as Apple
import Ludwig.Validation as Validation
fun noProcessesInTheFugueAccount(rule: Apple.Rule) -> Validation:
  case rule.(Apple.Rule).action of
  | Apple.AccountAction action ->
    if action == Apple.AccountRunProcess then
    let msg: “The AccountRunProcess permission is not allowed in the fugue account.”
    case rule.(Apple.Rule).subject of
      | Apple.AccountType account -> case account of
                        | Apple.AllAccounts -> Validation.failure(msg)
                            | Apple.Account acct -> if acct.accountId == “fugue-
12345678” then
                                      Validation.failure(msg)
                                    else
                                      Validation.success
      |_-> Validation.success
    else Validation.success
  |_ -> Validation.success
validate noProcessesInTheFugueAccount
```

In the above code, the system administrator can import a library called Fugue.System.Apple by inserting the line of code which reads as “import Fugue.System.Apple as Apple” which can include the definitions of the type Apple. The system administrator can also import the validations library by inserting the line of code which reads as “import Ludwig.Validation as Validation.” Then the system administrator can proceed to define the validation function for type “Apple” by defining a function called “noProcessesInTheFugueAccount” as shown above. Finally, the system can register the validation provided above to the type “Apple” by inserting the line of code which reads as “validate noProcessesInTheFugueAccount.”

Once the validation for the type “Apple” has been created by the system administrator, a user can use that validation to validate his or her own instantiations of the type Apple when generating his or her own code. An example of a user using the Apple validation is shown below:

```
import Fugue.System.Apple as Apple
import NoProcessesInFugueAccount
user1: Apple.User {userId: “user1”}
fugueAccount: Apple.Account {accountId: “fugue-12345678”}
devAccount: Apple.Account {accountId: “dev-12345678”}
runProcessRule: Apple.accountRules {
  principals: [user1],
  accounts: [
  fugueAccount,
  devAccount,
  ],
  actions: Apple.allAccountActions,
}
```

In the example above, the user can import the library called Fugue.System.Apple by inserting the line of code which reads as “import Fugue. System.Apple as Apple,” which can include the definitions of the type Apple. The system administrator can also import the NoProccesesInFugue library created by the system administrator as described above by inserting the line of code which reads as “import NoProcessesInFugueAccount.” Once the appropriate libraries have been imported, the user can define his or her own code as shown in the example above.

The validations (as defined by the system administrator) on the type Apple can be run by using the compiler normally. In this example below, the compiler can be run from the user's laptop or desktop (i.e., the client machine).

```
$ lwc Apple.lw
ludwig (evaluation error):
  “/opt/fugue/lib/Fugue/System/Apple.lw” (line 81, column 39):
  error:
  81| L.map(fun(t): case t of (p, a) -> Rule{principal: p, subject: AccountType(account),
action: AccountAction(a) }, L.cartesian-product(principals, actions))
∧∧∧∧∧∧∧∧∧∧∧∧∧∧∧∧∧∧∧∧∧∧∧∧∧∧∧∧∧∧∧∧∧∧∧∧∧∧∧∧∧∧∧∧∧
  Failed validations:
  - The AccountRunProcess permission is not allowed in the fugue account. (from
NoProcessesInFugueAccount.noProcessesInTheFugueAccount)
  Stack trace:
  In call to fat “/opt/fugue/lib/Ludwig/List.lw” (line 133, column 32)
  In call to map at “/opt/fugue/lib/Fugue/System/Apple.lw” (line 81, column 5)
  In call to singleAccountRules at “/opt/fugue/lib/Fugue/System/Apple.lw” (line 77, column
38)
  In call to fat “/opt/fugue/lib/Ludwig/List.lw” (line 133, column 32)
  In call to map at “/opt/fugue/lib/Fugue/System/Apple.lw” (line 77, column 24)
  In call to accountRules at “Apple.lw” (line 9, column 17)
```

In this way, if the user's use of the type Apple is in compliance with the policy set by the system administrator in the validations library for the type Apple, then the user-generated code can compile normally. On the other hand, if the user's use of the of the type Apple is not in compliance with the policy set by the system administrator in the validations library for the type Apple, then the user-generated code may fail to compile, and the user will be notified of the compilation error.

The domain-specific programming language described can be useful to a system architect looking to quickly build and maintain a computing system insofar as it allows the architect and/or developer to use a simplistic and custom coding language to declare instances of computing infrastructure rather than having to build the infrastructure using direct commands to a cloud service provider API.

However, for the architect who has already built or maintained a cloud-based computing system on a cloud service provider without using a domain-specific programming language, switching the development process of building computing infrastructure to employ a domain-specific programming language that can then be used by a cloud operating system to build and maintain the cloud-computing system can be untenable. In such a scenario, an organization can have a portion of its computing infrastructure built and maintained manually and another portion of its computing infrastructure being built and maintained automatically using a cloud operating system that is utilizing user-declared infrastructure via a domain-specific programming language.

Providing a user with an ability to use his or her pre-existing cloud computing system to generate a domain-specific programming language program can provide a pathway towards allowing the user/organization to fully enjoy the benefits associated with a domain-specific programming language and the building and maintaining of computing infrastructure using the programming language in conjunction with a cloud operating system.

In order to generate a domain-specific programming language program from an existing cloud implement computing system, a transcriber tool can be provided that processes an existing computing system stored on a cloud service provider and generates a domain-specific programming language file that can represent the a code that, if executed by a cloud operating system, would generate an identical computing system. The process by which the transcriber tool generates the domain-specific programming language program is described below.

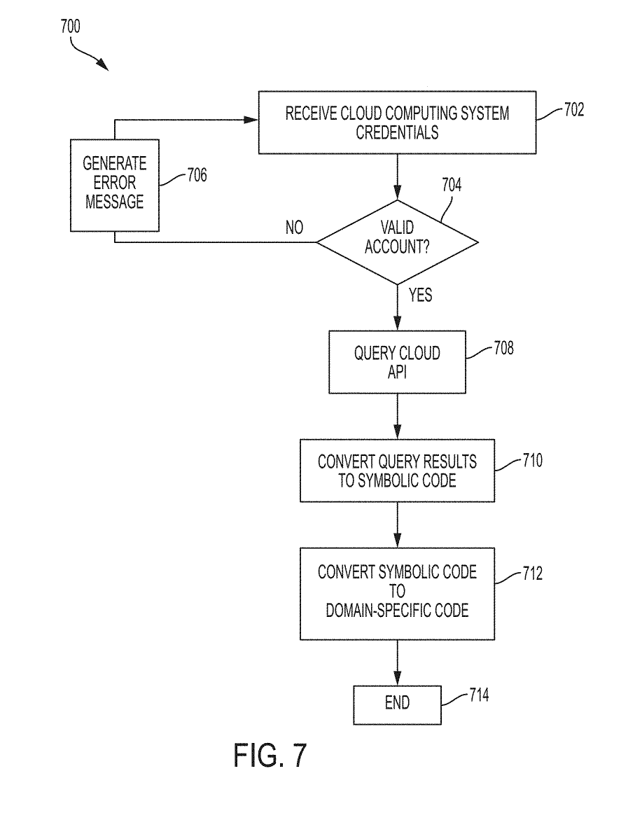

FIG. 7 illustrates an exemplary method for generating a domain-specific programming language file from a pre-existing cloud implemented computing system according to examples of the disclosure. The method 700 can begin at step 702 wherein a user can input information that can allow the transcriber tool to be pointed at the desired cloud based computing system and gain access to it. In some examples, the type of information the user can input can include authentication information (i.e., cloud service account identification and password) that will allow the transcriber access to the computing system) and any tokens associated with the cloud computing system, and in some examples the user can specify the resources within the cloud computing account that they wish to have transcribed into a domain specific programming language program.

Once the information described above is received at step 702, the method 700 can move to step 704 wherein the transcriber tool attempts to gain access to the cloud computing account within which the computing system sought to be transcribed is stored. In one example, if the user provides the network ID of the cloud computing system as well as the credentials needed to gain access to the cloud computing account, the transcriber tool can attempt to access the cloud computing account at step 704. If the transcriber tool is unable to gain access, then the method 700 can move to step 706 wherein an error message is generated indicating that the transcriber was unable to gain access to the account, and the method can then move back to step 702 wherein the user is prompted for his or her account credentials.

If the system, however, is able to gain access to the cloud, then the method 700 can move to step 708 wherein the cloud computing account located on the cloud service provided is queried to determine the resources that are located on the account. As described above, a user can specify the precise resources that they wish to recreate using a domain-specific programming language. Based on the user's specifications, and also based on the cloud service provider to which the query is to be directed, the transcriber tool can generate one or more queries to determine the resources that exist in the computing system that is implemented on the cloud.

Each individual cloud service provider (i.e., Amazon AWS, Google Cloud, etc.,) can include multiple APIs that can be invoked to query for running resources (i.e., elements of the computing system). In order to get a complete picture of the resources running within a cloud computing account, a substantial amount of the APIs available on a cloud service provider can be queried. Each query to an API of a cloud service provider can yield back a list of the instances that are currently running in the account and information pertaining to the identified instances. In some examples, additional queries can be performed around a particular instance of computing infrastructure in order to gather details that were not found in the initial queries. In some examples, the number of queries and the types of queries can be predetermined while certain input information needed for the queries can be determined from a user's specification of the desired computing resources to be scanned.

The results of the multiple queries can yield a large amount of data that can be processed in order to ultimately yield code written in a domain-specific programming language. Furthermore, the format of the results can depend on to which cloud service provider the query was directed. For instance, using Amazon AWS, a query result could be in the format below:

```
{
  “Table”: {
    “TableArn”: “arn:aws:dynamodb:us-west-2:674509505459:table/
    TranscriberTest”,
    “AttributeDefinitions”: [
      {
        “AttributeName”: “created_date”,
        “AttributeType”: “S”
      },
      {
        “AttributeName”: “entity_hash”,
        “AttributeType”: “S”
      },
      {
        “AttributeName”: “primary_id”,
        “AttributeType”: “S”
      },
      {
        “AttributeName”: “priority”,
        “AttributeType”: “S”
      }
    ],
    “GlobalSecondaryIndexes”: [
      {
        “IndexSizeBytes”: 0,
        “IndexName”: “entity_hash-priority-index”,
        “Projection”: {
          “ProjectionType”: “ALL”
        },
        “ProvisionedThroughput”: {
          “NumberOfDecreasesToday”: 0,
          “WriteCapacityUnits”: 1,
          “ReadCapacityUnits”: 1
        },
        “IndexStatus”: “ACTIVE”,
        “KeySchema”: [
          }
            “KeyType”: “HASH”,
            “AttributeName”: “entity_hash”
          },
          {
            “KeyType”: “RANGE”,
            “AttributeName”: “priority”
          }
        ],
        “IndexArn”: “arn:aws:dynamodb:us-west-
2:674509505459:table/TranscriberTest/index/entity_hash-priority-index”,
        “ItemCount”: 0
      }
    ],
    “ProvisionedThroughput”: {
      “NumberOfDecreasesToday”: 0,
      “WriteCapacityUnits”: 1,
      “ReadCapacityUnits”: 1
    },
    “TableSizeBytes”: 0,
    “TableName”: “TranscriberTest”,
    “TableStatus”: “ACTIVE”,
    “StreamSpecification”: {
      “StreamViewType”: “NEW_AND_OLD_IMAGES”,
      “StreamEnabled”: true
    },
    “LatestStreamLabel”: “2017-03-21T22:00:11.931”,
    “KeySchema”: [
      {
        “KeyType”: “HASH”,
        “AttributeName”: “primary_id”
      },
      {
        “KeyType”: “RANGE”,
        “AttributeName”: “created_date”
      }
    ],
    “ItemCount”: 0,
    “CreationDateTime”: 1490117237.214,
    “LatestStreamArn”: “arn:aws:dynamodb:us-west-
2:674509505459:table/TranscriberTest/stream/2017-03-21T22:00:11.931”
  }
}
```

As illustrated above, the results of a query can be complex and cumbersome. Furthermore, each individual query may not yield all of the information required to render domain-specific programming language code. Therefore, it may not be possible to render domain-specific language code directly from the query results. For instance, while individual queries can reveal the identities of various resources within the computing system, it may take multiple scans to infer relationships between the resources (i.e., in one or more resources are connected to each and communicate with one another). In some examples, various resources that exist within the computing system implemented on the cloud may be embedded in one another, and when implemented in domain-specific code those resources may be nested in one another. However, those relationships may not be established until all of the results of the queries are processed and understood, with any relationships between resources having been inferred from the results of the multiple queries.

Thus, in order to generate a complete picture of the computing system so as to convert it into a domain-specific programming language program, the entire system can be scanned through multiple queries to the cloud service APIs, and then the results of the scan can be post-processed so as to identify all of the resources within the computing system and the connections between them.

Returning to the example of FIG. 7, once the queries have been generated and the results received at step 708, the method 700 can proceed to step 710 wherein the results of the queries are converted into an intermediate symbolic representation. The intermediate symbolic representation can be the product of translating the query results and organizing them so that they can more readily be converted into domain-specific language code. As an example, as described above, the domain-specific programming language may contain one or more constructs that can be invoked by a user through his or her code declaration. Thus, in order to reverse engineer an already established cloud-based computing system, the results of the queries can be processed so as to symbolically determine the constructs that exist in the cloud-based computing system.

This concept can be applied to all the aspects of a domain-specific language, including identifiers and connections. For example, in addition to the example using constructs, the results of the queries can be used to determine any connections between resources within the computing system. The determined connections can be symbolically stored in memory, and then the stored symbols can be used to generate the domain-specific programming language program (discussed in further detail below).

In one example, a markup language can be used to generate the symbolic representation of the cloud-based computing system. A markup language file can parse the results of the queries, tag any results of the query that are pertinent to generating a domain-specific language program, and store in memory a symbolic representation of the computing system. In one example, a pre-determined markup file can be implemented in YAML (Yet Another Markup Language) format to process the query results and convert them into a symbolic representation. In one or more examples, the YAML file can be configured specifically for the cloud service provider from which the query results have been received. Since each cloud service provider contains a plurality of APIs that are specific to the cloud service provider, the form of the results of a query to any one of the cloud service providers may differ from cloud service provider to cloud service provider. Thus the markup language can be custom made for each individual cloud service provider. Thus, as an example, if the user account of interest is located on Amazon's AWS, then the markup file associated with Amazon AWS can be used to process the query results and convert them into a symbolic representation. The code below provides an example of a code written in YAML that converts Amazon AWS query results into a symbolic representation for ultimate conversion into a program written in Fugue's™ Ludwig™ programming language:

| # Mappings file for AWS DynamoDB service | |
|---|---|
| --- | |
| DynamoDB: | |
| Table: | |
| source_id: TableName | |
| maps: | |
| attributes: | |
| from: AttributeDefinitions | |
| key: AttributeName | |
| value: AttributeType | |
| as: Dictionary<ScalarAttributeType> | |
| name: | |
| from: TableName | |
| as: String | |
| schema: | |
| from: KeySchema | |
| key: AttributeName | |
| value: KeyType | |
| as: Dictionary<KeyType> | |
| provisionedThroughput: | |
| as: Throughput | |
| localSecondaryIndexes: | |
| from: LocalSecondaryIndexes.KeySchema | |
| key: AttributeName | |
| value: KeyType | |
| as: Optional<Dictionary<LocalSecondaryIndex>> | |
| globalSecondaryIndexes: | |
| from: GlobalSecondaryIndexes | |
| key: IndexName | |
| value: . | |
| as: Optional<Dictionary<GlobalSecondaryIndex>> | |
| streamViewType: | |
| from: StreamSpecification.StreamViewType | |
| as: Optional<StreamViewType> | |
| region: | |
| as: Region | |
| ScalarAttributeType: | |
| style: lookup | |
| maps: | |
| S: S | |
| N: N | |
| B: B | |
| GlobalSecondaryIndex: | |
| style: record | |
| maps: | |
| schema: | |
| from: KeySchema | |
| key: AttributeName | |
| value: KeyType | |
| as: Dictionary<KeyType> | |
| projection: | |
| as: Projection | |
| provisionedThroughput: | |
| as: Throughput | |
| LocalSecondaryIndex: | |
| maps: | |
| indexName: | |
| as: String | |
| schema: | |
| key: AttributeName | |
| value: KeyType | |
| as: Dictionary<KeyType> | |
| projection: | |
| as: Projection | |
| Throughput: | |
| style: record | |
| maps: | |
| read: | |
| from: ReadCapacityUnits | |
| as: Int | |
| write: | |
| from: WriteCapacityUnits | |
| as: Int | |
| KeyType: | |
| style: lookup | |
| maps: | |
| HASH : HASH | |
| RANGE: RANGE | |
| Projection: | |
| style: match | |
| match_list: | |
| - | |
| match: “ProjectionType==‘ALL’” | |
| value: all | |
| - | |
| match: “ProjectionType==‘KEYS_ONLY’” | |
| value: keysOnly | |
| - | |
| match: NonKeyAttributes | |
| function_name: include | |
| ProjectionType: | |
| style: lookup | |
| maps: | |
| ALL : ALL | |
| KEYS_ONLY: KEYSONLY | |
| INCLUDE : INCLUDE | |
| StreamViewType: | |
| style: lookup | |
| maps: | |
| NEW_IMAGE | : NewImageView |
| OLD_IMAGE | : OldImageView |
| NEW_AND_OLD_IMAGES: NewAndOldImagesView | |
| KEYS_ONLY | : KeysOnly View |

The markup file can be configured to look at particular parts of the query results so as to generate the symbols that can coincide with domain-specific programming language code parts. In one example, the queries to a cloud service provider API can return one or more instance and one or more unique identifiers from the cloud service provider associated with the instance. The transcriber tool can analyze all of the unique identifiers and can key off of each one such that when it comes time to generate the domain-specific language code, the transcriber tool (via the markup file) can use the unique identifiers to generate the resources and connections between resources. In case any resources are missing, i.e., the query results indicate that a resource is communicating with another resource, but one of the resources has a missing identifier, the transcriber tool can be configured to generate an external reference in the symbolic representation (via the markup language). Thus, in one or more examples, as the query results are processed and converted to domain-specific programming language code, the resources that have been scanned as part of the queries, and any undefined resources, can be converted into an external reference.

In another example, the markup language file can include instruction for associating the network IDs of resources found in the query results with the resource's corresponding symbols. So, for instance, if the markup file notes a load balancer in the query results, and stores a symbolic representation of the load balancer, the markup file can also ensure that the network ID of the load balancer as returned by the query is also associated with the symbolic representation of the load balancer.

The output of step 710 can be a symbolic representation of the cloud-based computing system, wherein the symbols correlate to features of the domain-specific language code. Thus, the symbolic representation can be used to generate the domain-specific code because, in some examples, the symbolic representation is essentially organized like the code would be but without the formal syntax of the programming language. Multiple query results can be analyzed using the mark-up language file, to parse the query results and organize the results into symbolic representations (that include information about the resources), wherein each symbolic representation can correlate to various parts of code within the domain-specific programming language.

As explained in further detail below, by organizing the code into a symbolic representation that correlates with the syntax and architecture of the domain-specific programming language code, the final step of generating code based on the cloud-based computing system can be simplified.

Once the symbolic representation of the code is generated at step 710, the process can move to step 712, wherein the symbolic representation of the computing system that is stored in memory can be finally converted into the domain-specific language program. As discussed above, the symbolic representation generated from the results of the queries can be correlated to the syntax of the domain-specific language. In other words, the symbolic representation can be organized and information can be stored in a format that is substantially identical to the way the domain-specific language program might declare computing infrastructure, however, the symbolic representation may not be written in the particular syntax of the domain-specific programming language. Thus, at 712, the symbolic representation can be used to generate code in the domain-specific programming language by converting each symbolic representation into its corresponding part of the domain-specific programming language.

At step 712, the symbolic mode can be deserialized and converted to code written in the domain-specific programming language syntax. Furthermore, the code generated at step 712 can be formatted in a manner that is commensurate with a domain-specific programming language that is handwritten by a user. For instance, if the symbolic representation includes resources that are nested within one another, then the resulting domain-specific programming language code can be written so that the resources nested within resources can be written at different level of indentation than non-nested resources. The code example below can represent an exemplary domain-specific language file (in this particular example Fugue's Ludwig language) generated from the example query results provided above with respect to the discussion of step 708:

```
composition
import Fugue.AWS as AWS
import Fugue.AWS.DynamoDB as DynamoDB
############################################################
# Region
# From local AWS setting: us-west-1
############################################################
region: AWS.Us-west-1
############################################################
# Table
#  Generated from AWS resource: TranscriberTest
############################################################
dynamodb-table-1: DynamoDB.Table.new {
  attributes: {
  “created_date”: DynamoDB.S,
  “entity_hash”: DynamoDB.S,
  “primary_id”: DynamoDB.S,
  “priority”: DynamoDB.S,
  },
  globalSecondaryIndexes: {
  “entity_hash-priority-index”: {
  projection: DynamoDB.Projection.all,
    provisionedThroughput: {
    read: 1,
    write: 1,
    },
    schema: {
    “entity_hash”: DynamoDB.HASH,
    “priority”: DynamoDB.RANGE,
    },
  },
  },
  name: “TranscriberTest”,
  provisionedThroughput: {
  read: 1,
  write: 1,
  },
  region: region,
  schema: {
  “created_date”: DynamoDB.RANGE,
  “primary_id”: DynamoDB.HASH,
  },
  streamViewType: DynamoDB.NewAndOldImagesView,
}
```

Once the domain-specific language program has been generated from the cloud based computing system, a user can utilize the code in multiple ways. In one example, the user can use the generated domain-specific language code to create a visualization of his or her computing system. In another example, described in further detail below, the user can compile the code and transmit it to a cloud operating system so as to either clone the cloud-based computing system from which domain-specific language file

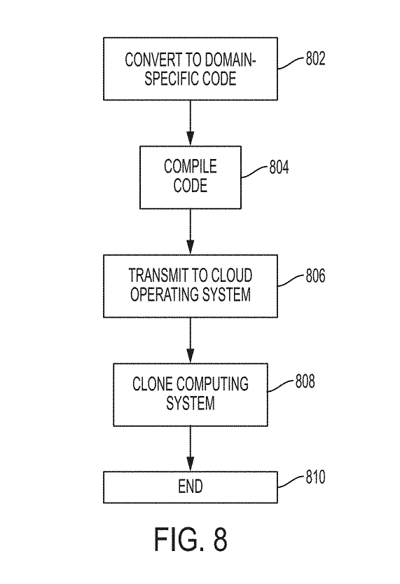

FIG. 8 illustrates an exemplary method of cloning a cloud-based computing system by generating a domain-specific program file from a pre-existing cloud implemented computing system according to examples of the disclosure. The method 800 can start with step 802 wherein a pre-existing cloud-based computing system is converted into a domain-specific programming language program using the method described above with respect to FIG. 7. Once the domain-specific language program has been created, the process can move to step 804 wherein the code is compiled (i.e., the variables are checked against a state information service to determine whether they exist and are in scope, see discussion above) and validated (see also discussion above). Once the code has been compiled, the method 800 can move to step 806 wherein an executable program output by the compiler can be transmitted to a cloud operating system. Once received by the cloud operating system, the method 800 can move to step 808 wherein the domain-specific language program is executed by the cloud operating system to create a new computing system. Since the newly created computing system is based on code generated by transcribing a pre-existing cloud-based computing system, the newly created computing system can be said to be a clone of the pre-existing cloud-based computing system.

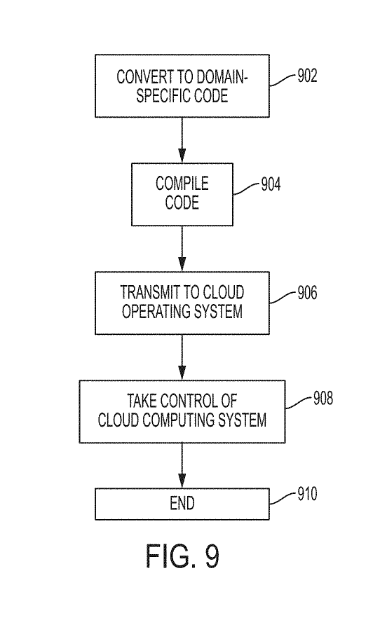

FIG. 9 illustrates an exemplary method of taking control of a cloud-based computing system by generating a domain-specific program file from a pre-existing cloud implemented computing system according to examples of the disclosure. In the example of FIG. 9, steps 902, 904, and 906 can be identical to steps 802, 804, and 806, respectively. Thus, for details regarding steps 902, 904, and 906, one can reference the discussion of his or her counterparts from the example of FIG. 8. Once the executable program is transmitted to the cloud operating system at step 906, the process can move to step 908 wherein the cloud operating system can take control of the pre-existing cloud-based computing system. Taking control of the system can refer to the process of maintaining the computing system and monitoring the cloud-based computing system to ensure that there is no configuration drift over time. In other words, rather than simply duplicating or cloning the computing system on which the generated domain-specific programming language file is based on, the system can instead access the cloud service provider where the computing system resides and take control of the system by accessing the cloud service provider's API to issue commands to the cloud service provider. These commands can include instructions to monitor the cloud-based computing system and instructions to adjust the cloud-based computing system in the event that there is any configuration drift detected.

In one or more examples, once the system converts the existing cloud-based computing system into a domain-specific programming language file, the system may utilize a validations library that when invoked will check the user-generated code to ensure that it complies with one or more desired policies. For example, once a domain-specific programming language file is generated for a pre-existing computing system similar to the examples of FIG. 8 and FIG. 9, the generated code can be checked to determine if it complies with a particular policy regime. Examples of policy regimes can include General Data Protection Regulation (GDPR) or the Health Insurance Portability and Accountability Act (HIPAA) data privacy policies.

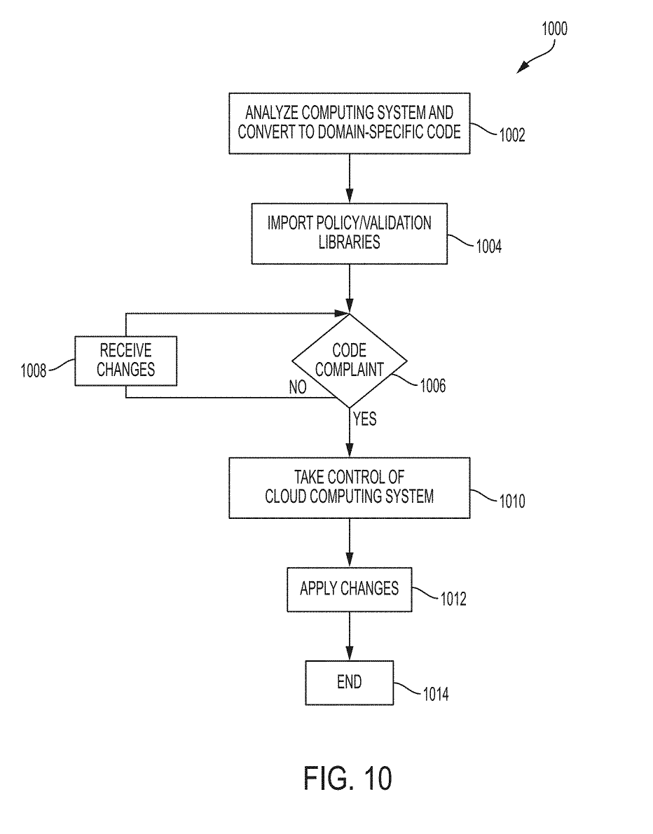

FIG. 10 illustrates an exemplary process for applying validations to domain-specific programming language files generated from pre-existing cloud-based computing system according to examples of the disclosure. In the example of FIG. 10, the process 1000 can begin at step 1002 wherein the system analyzes a pre-existing cloud-based computing system (i.e., computing system that is implemented on a cloud service provider) and process the exiting computing system to generate a domain-specific programming language file similar to the examples of steps 802 and 902 of FIGS. 8 and 9, respectively.

Once the domain-specific programming language file has been generated at step 1002, the process 1000 can move to step 1004 wherein one or more policy/validation libraries are imported into the file. As discussed above, validation libraries can be imported into a domain specific programming language file such that when the file is compiled. The imported validation library is used to check the domain-specific language file's compliance with one or more policies included in the validation library.

Once the validation library is imported into the generated domain-specific programming language file at step 1004, the process can move to step 1006 wherein the code is compiled (similar to steps 804 and 904 of FIGS. 8 and 8, respectively) and the compiled code is analyzed to determine whether it is compliant with one or more policies expressed in the imported validation file. A use case can help to exemplify the process of determining compliance. For instance, if a validation library imported into a domain-specific programming file included a prohibition on opening a particular port of a computing system but the actual file generated at step 1002 included code that opened such a port, then the domain-specific file would be determined to not comply with the imported validation library.

If at step 1006 the domain-specific programming language file is found to not be compliant, the user of the system can be notified, and the process can move to step 1008 wherein the system can wait to receive one or more changes to the domain-specific programming language file from the user to remedy the non-compliance of the generated file. Once the changes have been received, the process can revert back to step 1006 wherein the file is checked to determine whether or not it is compliant with the validations imported at step 1004.

Once the generated domain-specific programming file is found to be compliant at step 1006, the process can move to step 1010 wherein the system can take control of the cloud-based computing system in substantially the same way as discussed at step 908 with respect to FIG. 9. Once the system has taken control of the cloud computing system at step 1012, the system can then apply any changes generated at step 1008 to the cloud-based computing system, thereby ensuring the deployed real-world system is in compliance with the one or more validations and policies chosen by the user of the system. Once the changes have been implemented at step 1012, the process can move to step 1014 wherein the process 1000 is terminated.

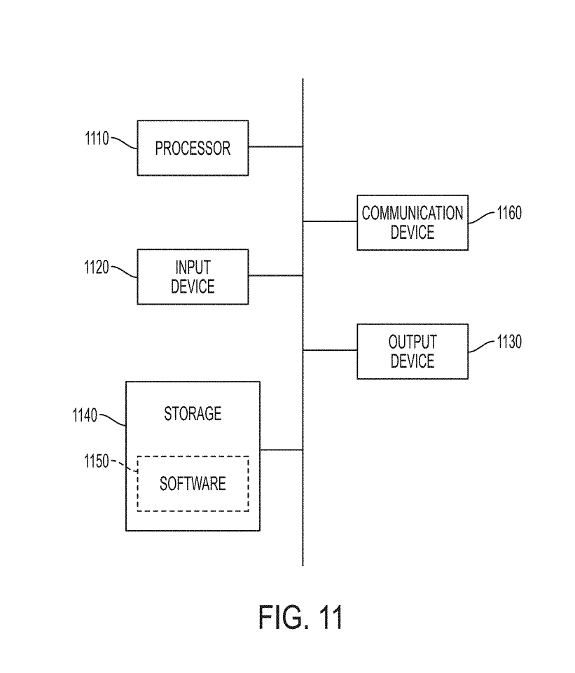

FIG. 11 illustrates an example of a computing device in accordance with one embodiment. Device 1100 can be a host computer connected to a network. Device 1100 can be a client computer or a server. As shown in FIG. 11, device 1100 can be any suitable type of microprocessor-based device, such as a personal computer, workstation, server, or handheld computing device (portable electronic device) such as a phone or tablet. The device can include, for example, one or more of processor 1110, input device 1120, output device 1130, storage 1140, or communication device 1160. Input device 1120 and output device 1130 can generally correspond to those described above and can either be connectable or integrated with the computer.

Input device 1120 can be any suitable device that provides input, such as a touch screen, keyboard or keypad, mouse, or voice-recognition device. Output device 1130 can be any suitable device that provides output, such as a touch screen, haptics device, or speaker.

Storage 1140 can be any suitable device that provides storage, such as an electrical, magnetic, or optical memory, including a RAM, cache, hard drive, or removable storage disk. Communication device 1160 can include any suitable device capable of transmitting and receiving signals over a network, such as a network interface chip or device. The components of the computer can be connected in any suitable manner, such as via a physical bus or wirelessly.

Software 1150, which can be stored in storage 1140 and executed by processor 1110, can include, for example, the programming that embodies the functionality of the present disclosure (e.g., as embodied in the devices as described above).

Software 1150 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1140, that can contain or store programming for use by or in connection with an instruction execution system, apparatus, or device.

Software 1150 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1100 can implement any operating system suitable for operating on the network. Software 1150 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

What is claimed is:

1. A method for generating a domain-specific programming language program from a pre-existing cloud-based computing system, the method comprising:
receiving access information about the pre-existing cloud-based computing system, wherein the access information includes a location of the pre-existing cloud-based computing system and authentication information to gain access to the pre-existing cloud-based computing system;
generating one or more queries to one or more application program interfaces (APIs) of a cloud service provider, wherein the pre-existing cloud-based computing system is stored on one or more computing resources of the cloud service provider, and wherein the generated one or more queries is based on the cloud service provider being used to store the pre-existing cloud-based computing system;
generating a symbolic representation of the pre-existing cloud-based computing system wherein the generated symbolic representation is based on one or more results of the one or more queries, and wherein the generated symbolic representation is also based on a domain-specific programming language; and
converting the symbolic representation of the pre-existing cloud-based computing system into the domain-specific programming language program.

2. The method of claim 1, wherein the symbolic representation of the pre-existing cloud-based computing system includes one or more symbols, and wherein the one or more symbols correlated to one or more features of the domain-specific language code.

3. The method of claim 2, wherein converting the symbolic representation of the pre-existing cloud-based computing system into the domain-specific programming language program includes converting the one or more symbols into a syntax associated with the domain-specific programming language.

4. The method of claim 1, wherein the method further comprises using the generated domain-specific programming language file to monitor the pre-existing cloud-based computing system and determine whether any configuration drift occurs during an operation period of the cloud-based computing system.

5. The method of claim 4, wherein the method further comprises using the generated domain-specific programming language file to implement one or more changes to the pre-existing cloud-based computing system, wherein the one or more changes to the pre-existing cloud-based computing system are based on one or more changes to the generated domain-specific programming language file.

6. The method of claim 1, wherein the method comprises generating a second cloud-based computing system based on the generated domain-specific programming language file.

7. The method of claim 1, wherein the method further comprises:
receiving one or more declarations of policy; and
determining whether the domain-specific programming language program complies with the one or more declarations of policy.

8. The method of claim 7, wherein the method further comprises:
receiving one or more modifications to the generated domain-specific programming language file if it is determined that the domain-specific programming language program fails to comply with the one or more declarations of policy; and
using the modified domain-specific programming language file to implement one or more changes to the pre-existing cloud-based computing system, wherein the one or more changes to the pre-existing cloud-based computing system are based on the one or more modifications to the generated domain-specific programming language file.

9. A non-transitory computer readable storage medium having stored thereon a set of instructions for processing instructions of a software program that, when executed by a computing device, causes the computing device to:
receive access information about the pre-existing cloud-based computing system, wherein the access information includes a location of the pre-existing cloud-based computing system and authentication information to gain access to the pre-existing cloud-based computing system;
generate one or more queries to one or more application program interfaces (APIs) of a cloud service provider, wherein the pre-existing cloud-based computing system is stored on one or more computing resources of the cloud service provider, and wherein the generated one or more queries is based on the cloud service provider being used to store the pre-existing cloud-based computing system;
generate a symbolic representation of the pre-existing cloud-based computing system wherein the generated symbolic representation is based on one or more results of the one or more queries, and wherein the generated symbolic representation is also based on a domain-specific programming language; and
convert the symbolic representation of the pre-existing cloud-based computing system into the domain-specific programming language program.

10. The non-transitory computer readable storage medium of claim 9, wherein the symbolic representation of the pre-existing cloud-based computing system includes one or more symbols, and wherein the one or more symbols correlated to one or more features of the domain-specific language code.

11. The non-transitory computer readable storage medium of claim 10, wherein converting the symbolic representation of the pre-existing cloud-based computing system into the domain-specific programming language program includes converting the one or more symbols into a syntax associated with the domain-specific programming language.

12. The non-transitory computer-readable storage medium of claim 9, wherein the computing device is further caused to use the generated domain-specific programming language file to monitor the pre-existing cloud-based computing system and determine whether any configuration drift occurs during an operation period of the cloud-based computing system.

13. The non-transitory computer readable storage medium of claim 12, wherein the computing device is further caused to use the generated domain-specific programming language file to implement one or more changes to the pre-existing cloud-based computing system, wherein the one or more changes to the pre-existing cloud-based computing system are based on one or more changes to the generated domain-specific programming language file.

14. The non-transitory computer readable storage medium of claim 9, wherein the computing device is further caused to generate a second cloud-based computing system based on the generated domain-specific programming language file.

15. The non-transitory computer readable storage medium of claim 9, wherein the computing device is further caused to:
receive one or more declarations of policy; and
determine whether the domain-specific programming language program complies with the one or more declarations of policy.

16. The non-transitory computer readable storage medium of claim 15, wherein the computing device is further caused to:
receive one or more modifications to the generated domain-specific programming language file if it is determined that the domain-specific programming language program fails to comply with the one or more declarations of policy; and
use the modified domain-specific programming language file to implement one or more changes to the pre-existing cloud-based computing system, wherein the one or more changes to the pre-existing cloud-based computing system are based on the one or more modifications to the generated domain-specific programming language file.

17. A computing device, the computing device comprising:
a memory;
one or more processors; and
wherein the memory stores one or more programs that when executed by the one or more processors causes the one or more process to:
receive access information about a pre-existing cloud-based computing system, wherein the access information includes a location of the pre-existing cloud-based computing system and authentication information to gain access to the pre-existing cloud-based computing system;
generate one or more queries to one or more application program interfaces (APIs) of a cloud service provider, wherein the pre-existing cloud-based computing system is stored on one or more computing resources of the cloud service provider, and wherein the generated one or more queries is based on the cloud service provider being used to store the pre-existing cloud-based computing system;
generate a symbolic representation of the pre-existing cloud-based computing system wherein the generated symbolic representation is based on one or more results of the one or more queries, and wherein the generated symbolic representation is also based on a domain-specific programming language; and
convert the symbolic representation of the pre-existing cloud-based computing system into the domain-specific programming language program.

18. The computing device of claim 17, wherein the symbolic representation of the pre-existing cloud-based computing system includes one or more symbols, and wherein the one or more symbols correlated to one or more features of the domain-specific language code.

19. The computing device of claim 18, wherein converting the symbolic representation of the pre-existing cloud-based computing system into the domain-specific programming language program includes converting the one or more symbols into a syntax associated with the domain-specific programming language.

20. The computing device of claim 17, wherein the one or more processors are further caused to use the generated domain-specific programming language file to monitor the pre-existing cloud-based computing system and determine whether any configuration drift occurs during an operation period of the cloud-based computing system.

21. The computing device of claim 20, wherein the one or more processors are further caused to use the generated domain-specific programming language file to implement one or more changes to the pre-existing cloud-based computing system, wherein the one or more changes to the pre-existing cloud-based computing system are based on one or more changes to the generated domain-specific programming language file.

22. The computing device of claim 17, wherein the one or more processors are further caused to generate a second cloud-based computing system based on the generated domain-specific programming language file.

23. The computing device of claim 17, wherein the one or more processors are further caused to:
receive one or more declarations of policy; and
determine whether the domain-specific programming language program complies with the one or more declarations of policy.

24. The computing device of claim 23, wherein the one or more processors are further caused to:
receive one or more modifications to the generated domain-specific programming language file if it is determined that the domain-specific programming language program fails to comply with the one or more declarations of policy; and
use the modified domain-specific programming language file to implement one or more changes to the pre-existing cloud-based computing system, wherein the one or more changes to the pre-existing cloud-based computing system are based on the one or more modifications to the generated domain-specific programming language file.
